(19) United States
(12) Patent Application Publication
(10) Pub. No.: US 2009/0022229 A1
(43) Pub. Date: Jan. 22, 2009

(54) Efficient image transmission between TV chipset and display device

(76) Inventor: Chih-Ta Star Sung, GLONN (DE)

Correspondence Address: Chih-Ta Star Sung, Rm. 308, Bld. 52, No. 195, Sec. 4, Chung Hsin Rd., Juhdong, 310, TW

(21) Appl. No.: 11/879,107

(22) Filed: Jul. 17, 2007

(51) Int. Cl. H04N 7/24

(52) U.S. Cl. 375/240.25; 375/E07.014

(57) ABSTRACT

Compression and decompression with high image quality is applied to reduce the data rate of transmitting an image results in high efficiency image transmission between TV and display device is presented. An LVDS bus is hooked between the TV side and display device with this invention of image compression apparatus in the TV side to reduce data rate and image decompression in the display device to reconstruct the image to be displayed.

### BACKGROUND OF THE INVENTION

1. Field of Invention

The present invention relates to apparatus of the image transmission between the TV chipset and the display device, and particularly relates to image compression in the TV chipset side and image decompression of the display device resulting in data reduction and fast transmission.

2. Description of Related Art

ISO and ITU have separately or jointly developed and defined some digital video compression standards including MPEG-1, MPEG-2, MPEG-4, MPEG-7, H.261, H.263 and H.264. The success of development of the video compression standards fuels wide applications which include video telephony, surveillance system, DVD, and digital TV. The advantage of digital image and video compression techniques significantly saves the storage space and transmission time without sacrificing much of the image quality.

Most ISO and ITU motion video compression standards adopt Y, U/Cb and V/Cr as the pixel elements, which are derived from the original R (Red), G (Green), and B (Blue) color components. The Y stands for the degree of “Luminance”, while the Cb and Cr represent the color difference been separated from the “Luminance”. In both still and motion picture compression algorithms, the 8×8 pixels “Block” based Y, Cb and Cr goes through the similar compression procedure individually.

There are essentially three types of picture encoding in the MPEG video compression standard. I-frame, the “Intra-coded” picture uses the block of 8×8 pixels within the frame to code itself. P-frame, the “Predictive” frame uses previous I-type or P-type frame as a reference to code the difference. B-frame, the “Bi-directional” interpolated frame uses previous I-frame or P-frame as well as the next I-frame or P-frame as references to code the pixel information. In principle, in the I-frame encoding, all “Block” with 8×8 pixels go through the same compression procedure that is similar to JPEG, the still image compression algorithm including the DCT, quantization and a VLC, the variable length encoding. While, the P-frame and B-frame have to code the difference between a target frame and the reference frames.

In compressing or decompressing the P-type or B-type of video frame or block of pixels, the referencing memory dominates high semiconductor die area and cost. If the referencing frame is stored in an off-chip memory, due to I/O data pad limitation of most semiconductor memories, accessing the memory and transferring the pixels stored in the memory becomes bottleneck of most implementations. One prior method overcoming the I/O bandwidth problem is to use multiple chips of memory to store the referencing frame which cost linearly goes higher with the amount of memory chip. Some times, higher speed clock rate of data transfer solves the bottleneck of the I/O bandwidth at the cost of higher since the memory with higher accessing speed charges more and more EMI, Electro-Magnetic Interference problems in system board design. In MPEG2 TV application, a Frame of video is divided to be “odd field” and “even field” with each field being compressed separately which causes discrepancy and quality degradation in image when 2 fields are combined into a frame before display.

De-interlacing is a method applied to overcome the image quality degradation before display. For efficiency and performance, 3-4 of previous frames and future frames of image are used to be reference for compensating the potential image error caused by separate quantization. De-interlacing requires high memory I/O bandwidth since it accesses 3-5 frames.

In some display applications, frame rate or field rate need to be converted to fit the requirement of higher quality and the frame rate conversion is needed which requires referring to multiple frames of image to interpolate extra frames which consumes high bandwidth of memory bus as well.

The method of this invention of video de-interlacing and frame rate conversion coupled with video decompression and applying referencing frame compression significantly reduces the requirement of memory IO bandwidth and costs less storage device.

### SUMMARY OF THE INVENTION

The present invention is related to an efficient mechanism of image transmission between the TV chipset and the display device by compressing and decompressing the image data before TV and display device.
The present invention of the fast image transmission between the TV chipset and the display device compressing the image data in the TV side and decompressing the image in the display device.
According to an embodiment of this invention, the bit rate of an image frame is compressed before putting to an LVDS bus for transmission, and is reconstructed after receiving from the LVDS bus.
According to another embodiment of this invention, the maximum data rate of each image to be displayed is predetermined by setting a “Threshold” value to a register in the TV side.
According to another embodiment of this invention, the timing controller within the display device compresses the received image data from the LVDS bus and stores it into a temporary frame buffer, and decompressing the image before sending to the display drivers.
According to an embodiment of this invention, the timing controller within the display device compresses the received image data from the LVDS bus and stores it into a temporary frame buffer, and sending the accessed compressed image to the display driver. The display driver will then, decompress the image before driving out to the display panel.

It is to be understood that both the foregoing general description and the following detailed description are by examples, and are intended to provide further explanation of the invention as claimed.

### BRIEF DESCRIPTION OF THE DRAWINGS

FIG. 1 shows the basic three types of motion video coding.

FIG. 2 depicts a block diagram of a video compression procedure with two referencing frames saved in so named referencing frame buffer.

FIG. 3 illustrates the block diagram of video decompression.

FIG. 4 illustrates Video compression with interlacing mode.

FIG. 5 depicts the video de-interlacing and the frame rate conversion.

FIG. 6 depicts a prior art video TV sub-system and the display

FIG. 7 depicts this invention of TV s and the display sub-system with image compression in TV side and decompression in the display panel side.

FIG. 8 depicts another derivative method of this invention of TV and the display sub-system with image compression in the display panel side before saving to a temporary frame buffer and image decompression before sending to the display driver.

FIG. 9 depicts another derivative method of this invention of TV and display sub-system with image compression in the display panel side before saving to a temporary frame buffer and image decompression inside the display driver before driving out to the display panel.

### DESCRIPTION OF THE PREFERRED EMBODIMENTS

There are essentially three types of picture coding in the MPEG video compression standard as shown in FIG. 1. I-frame 11, the “Intra-coded” picture, uses the block of pixels within the frame to code itself. P-frame 12, the “Predictive” frame, uses previous I-frame or P-frame as a reference to code the differences between frames. B-frame 13, the “Bi-directional” interpolated frame, uses previous I-frame or P-frame 12 as well as the next I-frame or P-frame 14 as references to code the pixel information.

In most applications, since the I-frame does not use any other frame as reference and hence no need of the motion estimation, the image quality is the best of the three types of pictures, and requires least computing power in encoding since no need for motion estimation. The encoding procedure of the I-frame is similar to that of the JPEG picture. Because of the motion estimation needs to be done in referring both previous and/or next frames, encoding B-type frame consumes most computing power compared to I-frame and P-frame. The lower bit rate of B-frame compared to P-frame and I-frame is contributed by the factors including: the averaging block displacement of a B-frame to either previous or next frame is less than that of the P-frame and the quantization step is larger than that in a P-frame. In most video compression standard including MPEG, a B-type frame is not allowed for reference by other frame of picture, so, error in B-frame will not be propagated to other frames and allowing bigger error in B-frame is more common than in P-frame or I-frame. Encoding of the three MPEG pictures becomes tradeoff among performance, bit rate and image quality, the resulting ranking of the three factors of the three types of picture encoding are shown as below:

| | Performance | | |
|---|---|---|---|
| | (Encoding speed) | Bit rate | Image quality |
| I-frame | Fastest | Highest | Best |
| P-frame | Middle | Middle | Middle |
| B-frame | Slowest | Lowest | Worst |

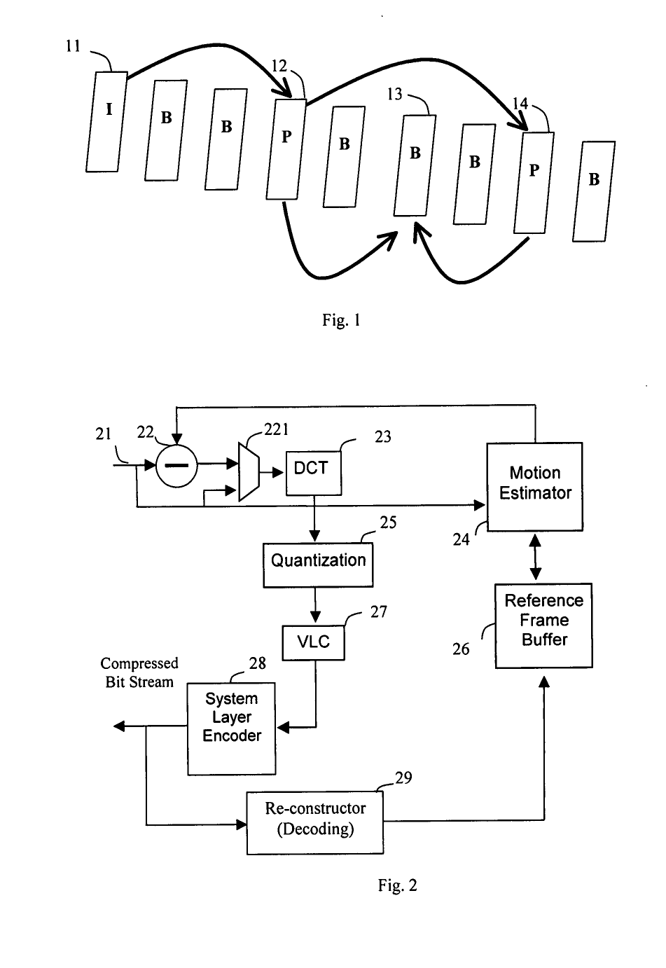

FIG. 2 shows the block diagram of the MPEG video compression procedure, which is most commonly adopted by video compression IC and system suppliers. In I-type frame coding, the MUX 221 selects the coming original pixels 21 to directly go to the DCT 23 block, the Discrete Cosine Transform before the Quantization 25 step. The quantized DCT coefficients are packed as pairs of “Run-Length” code, which has patterns that will later be counted and be assigned code with variable length by the VLC encoder 27. The Variable Length Coding depends on the pattern occurrence. The compressed I-type frame or P-type bit stream will then be reconstructed by the reverse route of decompression procedure 29 and be stored in a reference frame buffer 26 as future frames' reference. In the case of compressing a P-frame, B-frame or a P-type, or a B-type macro block, the macro block pixels are sent to the motion estimator 24 to compare with pixels within macroblock of previous frame for the searching of the best match macroblock. The Predictor 22 calculates the pixel differences between the targeted 8×8 block and the block within the best match macroblock of previous frame or next frame. The block difference is then fed into the DCT 23, quantization 25, and VLC 27 coding, which is the same procedure like the I-frame coding.

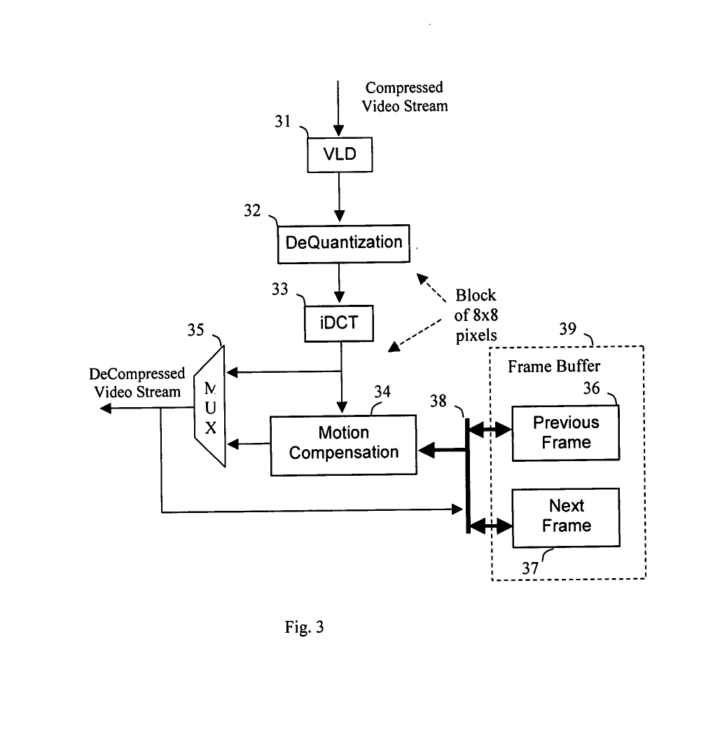

FIG. 3 illustrates the basic procedure of MPEG video decompression. The compressed video stream with system header having many system level information including resolution, frame rate, . . . etc. is decoded by the system decoder and sent to the VLD 31, the variable length decoder. The decoded block of DCT coefficients is shifted by the “Dequantization” 32 before they go through the iDCT 33, inverse DCT, and recovers time domain pixel information. In decoding the non intra-frame, including P-type and B-type frames, the output of the iDCT are the pixel difference between the current frame and the referencing frame and should go through motion compensation 34 to recover to be the original pixels. The decoded I-frame or P-frame can be temporarily saved in the frame buffer 39 comprising the previous frame 36 and the next frame 37 to be reference of the next P-type or B-type frame. When decompressing the next P-type frame or next B-type frame, the memory controller will access the frame buffer and transfer some blocks of pixels of previous frame and/or next frame to the current frame for motion compensation. Storing the referencing frame buffer on-chip costs high semiconductor die area and very costly. Transferring block pixels to and from the frame buffer consumes a lot of time and I/O 38 bandwidth of the memory or other storage device. To reduce the required density of the temporary storage device and to speed up the accessing time in both video compression and decompression, compressing the referencing frame image is an efficient new option.

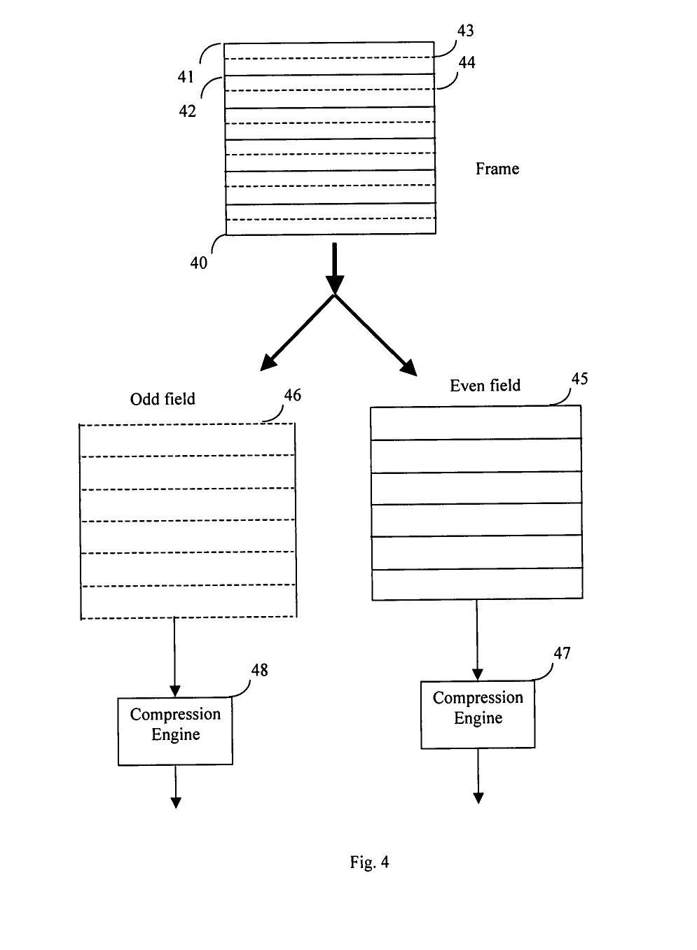

In some video applications like TV set, since the display frequency is higher than 60 frames per second (60 fps), most likely, interlacing mode is adopted, in which, as shown in FIG. 4, even lines 41, 42 and odd lines 43, 44 of pixels within a captured video frame will be separated and form “Eve field 45” and “Odd field 46” and compress them separately 48, 47 with different quantization parameters which causes loss and error and since the quantization is done independently.

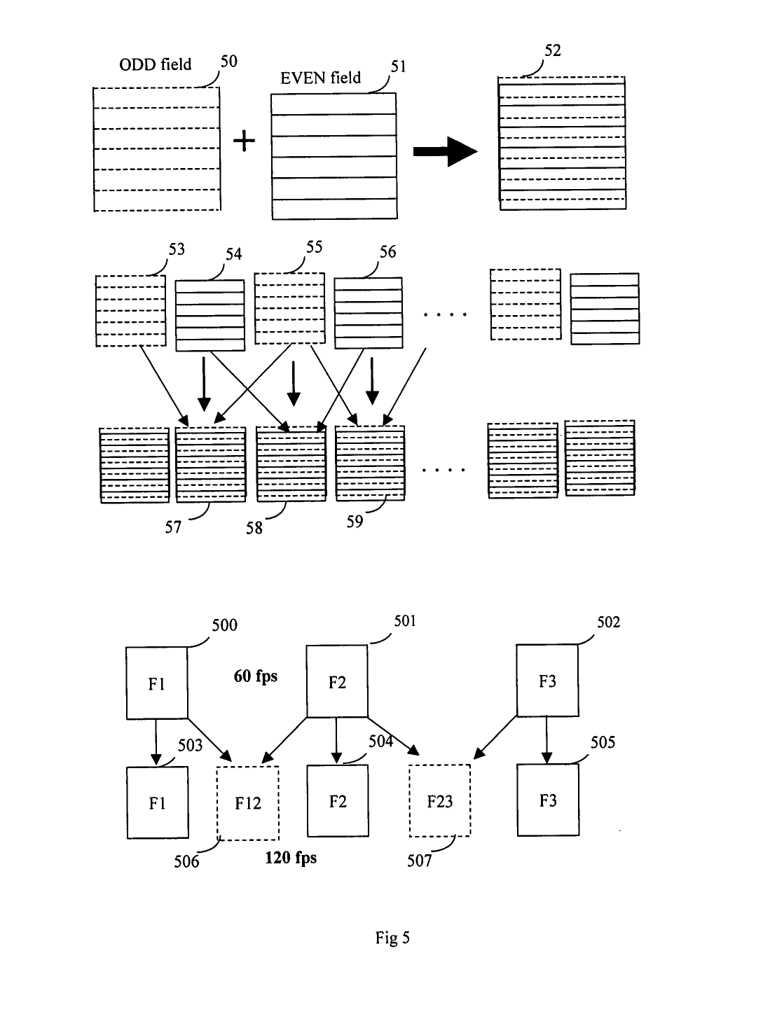

After decompression, when merging fields to be a “frame” again, the individual loss of different field causes obvious artifacts in some area like edge of an object like a line. In some applications including TV set as shown in FIG. 5, the interlaced images with odd field 50 and even field 51 will be re-combined to form “Frame” 52 again before displaying. The odd lines of even field position 57, 59 will be filled most likely by compensation means of adjacent odd fields 53, 55 . . . To minimize the artifact caused by video compression of interlacing mode, de-interlacing might apply not only adjacent previous and next fields, but also between 3 to 4 previous fields for compensation and to reconstruct the odd or even lines of pixels. It is obvious that de-interlacing requires reading multiple previous and next files of pixels which cost high memory IO bandwidth. Another procedure consuming a lot memory IO bandwidth is the frame rate conversion which interpolates and forms new frame between decoded frames. For a video with 30 frames per second or said 30 fps converting to 60 fps, or from a 60 fps converting to 120 fps, the easiest way is to repeat very frame which can not gain good image quality. One can also easily interpolate and form a new frame 506, 507 between every two existing adjacent frames 500, 501, 502. For gaining even better image quality, multiple previous frame and multiple future frames are read to compensate and interpolate to form the new frame which consumes high memory IO bandwidth.

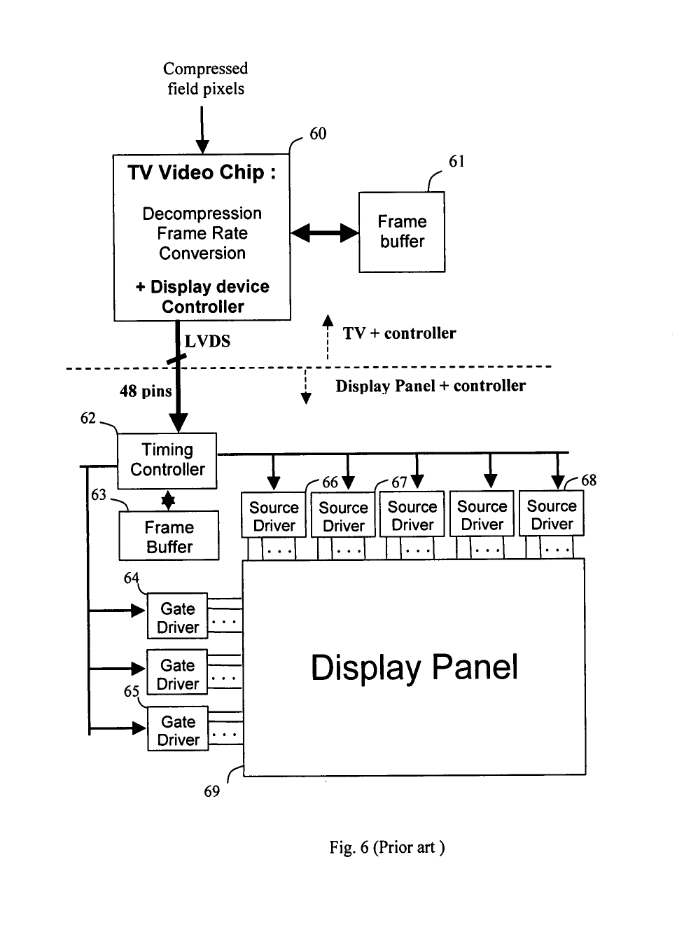

FIG. 6 depicts an example of the conventional means of the TV sub-system and the display device, for example, an LCD display panel. In the TV side, the TV chipset 60 includes features of at least but not limited to video decompression, de-interlacing and frame rate conversion. Each of the three procedures requires high traffic in reading and writing pixels from and to the frame buffers 61. Due to the heavy traffic on memory bus, and since commodity memory has limited data width like SDRAM, DDR or DDR2 they have most likely 8 bits or at most 16 bits wide are the main stream which costs less compared to 32 bits wide memory chips. Applying some multiple memory chips or widening the width of the memory IO bus become two most common solutions to provide the required IO bandwidth which is costly and results in difficulty in system board design and much EMI, Electro-Magnetic Interference problems can be introduced. In this invention, a compression code can be integrated into the TV chipset to help reducing the data rate of the image buffer before writing to the memory frame buffer and after reading from the memory buffer, the decoder reconstructs the image data and sends to the TV chipset. Y applying this approach, the data rate can be easily reduced by a factor of 2× or 3× and the memory bandwidth issues like cost and EMI, can be eased. In the prior art of TV-Display sub-system, the display device us comprised of a display unit 69 (or said, a display panel), a timing controller 62 which decides the timing and sending out the right lines of image to be displayed in the right position, row (or said gate) drivers 64, 65 of enabling the corresponding row of pixels sequentially and a couple of source drivers 66, 67, 68 (or said, the pixel data) to line by line drive our the source of data.

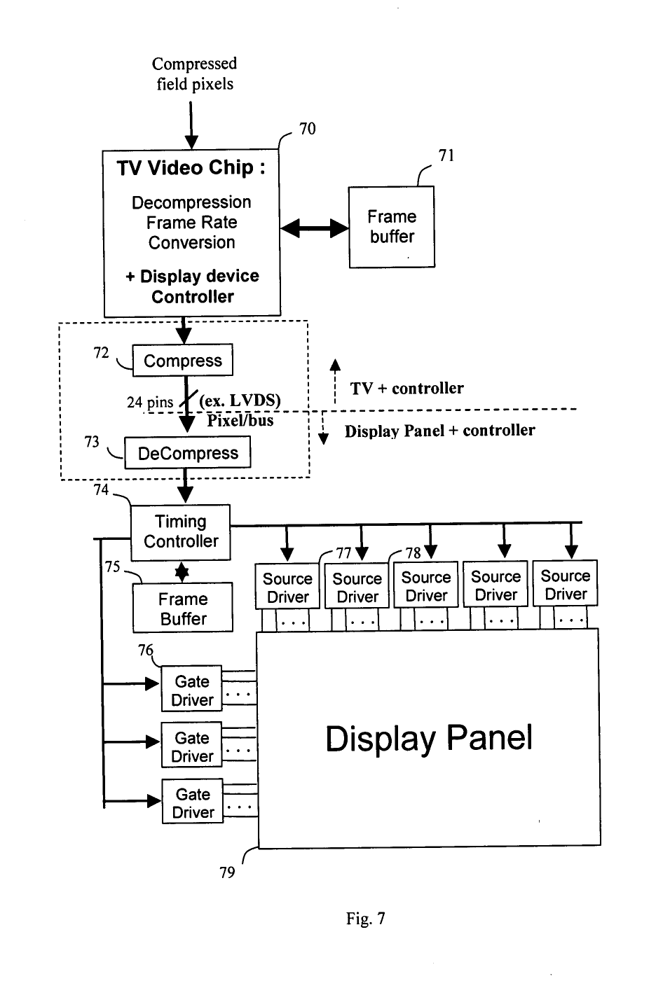

FIG. 7 illustrates this invention of efficient image transmission between a TV and the display device. A video bit stream with compressed or uncompressed format is input to the TV-video chip 70 which functions video decompression, de-interlacing, frame rate conversion . . . with at least two image temporarily stored into the frame buffer memory 71. A compression unit 72 is implemented in the TV side to reduce the data rate of the image and hence reduces the requirement of the IO bandwidth of the data bus for transmitting the image data. Another decompression unit 73 is implemented in the display (panel) side to reconstruct the image. A timing controller 74 calculates and decides the timing for each line of pixels to be displayed and sends the received image to a temporary frame buffer 75. When timing matched, the corresponding pixels will be accessed and sent to the display unit for presentation. The gate driver functions as a row selecting unit row y row turning on the corresponding row of pixels to be displayed. The source driver 77, 78 drive out the pixel line by line to the display unit. This invention reduces the bud width of transmission lines, for example, the LVDS, Low Voltage Differential Signal bus which is commonly used in transmitting high volume of image pixels.

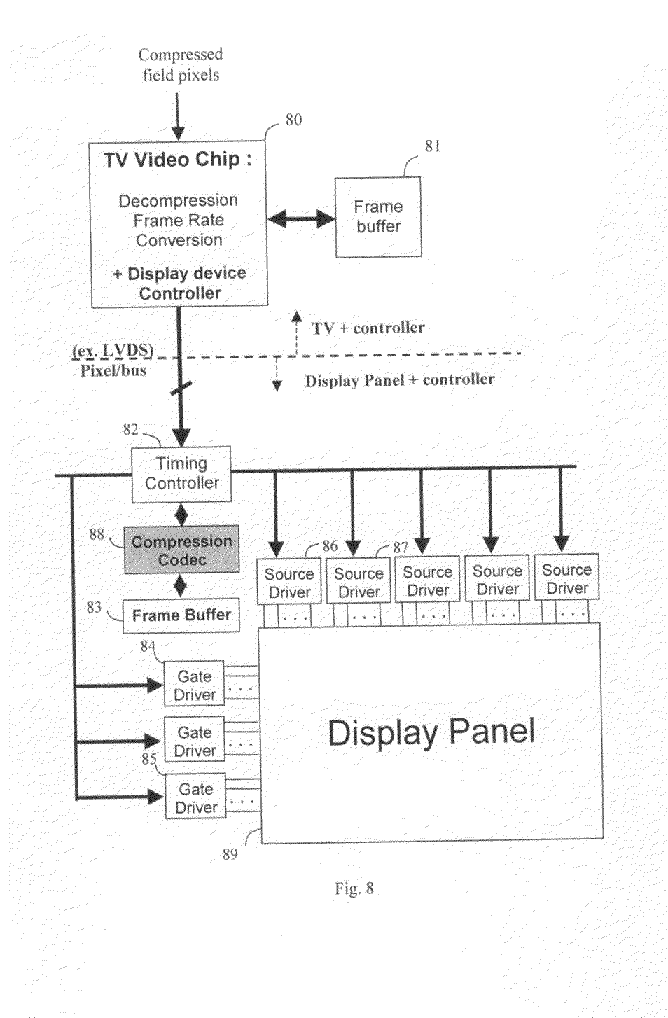

FIG. 8 shows an embodiment of this invention of efficient image transmission between a TV and the display device. A video bit stream with compressed or uncompressed format is input to the TV-video chip 80 which functions video decompression, de-interlacing, frame rate conversion . . . and at least two frames of images stored into the frame buffer memory 81. A timing controller 82 coupled between the TV and the display device receives the image data and compresses 88 them before sending to the frame buffer 83. The compression codec also reconstructs the compressed image data and reconstructs them before line by line sending the pixels to the display drivers 86, 87 for display. A timing controller 82 receives image data, calculates and decides the timing for each line of pixels to be displayed. When timing matched, the corresponding pixels will be accessed and sent to display drivers for presentation. While, the gate drivers 84, 85 function as a row selecting unit row by row turning on the corresponding row of pixels to be displayed.

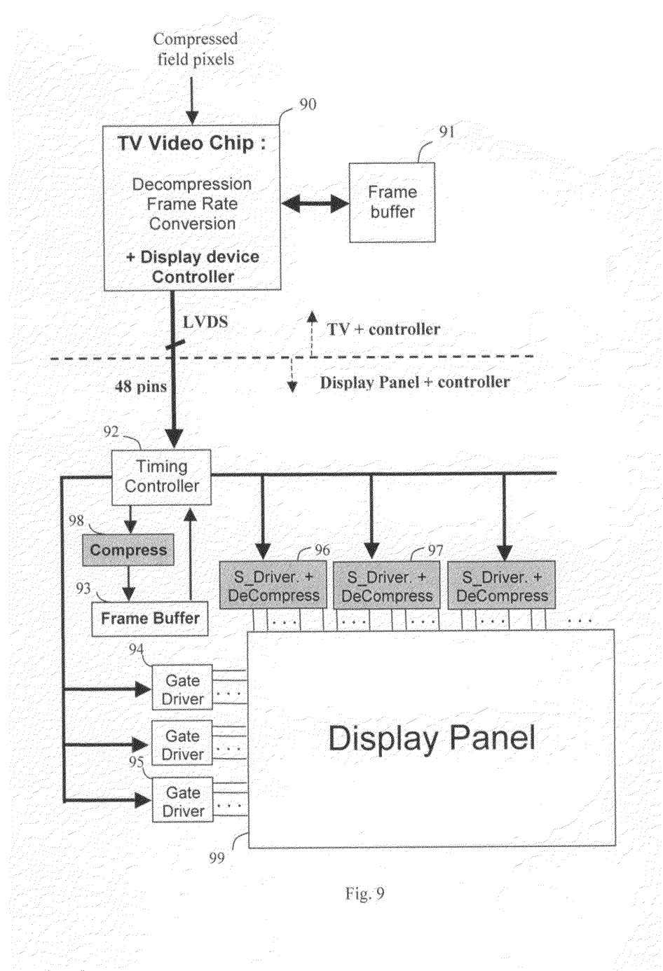

FIG. 9 shows another derivative embodiment of this invention of efficient image transmission between a TV and the display device. A video bit stream with compressed or uncompressed format is input to the TV-video chip 90 which functions video decompression, de-interlacing, frame rate conversion . . . and at least two frames of images stored into the frame buffer memory 91. A timing controller 92 coupled between the TV and the display device receives the image data and compresses 98 them before sending to the frame buffer 93. Timing controller 92 accesses the compressed image data and sends to the display drivers 96, 97 for display. There is image decompression unit embedded inside each of the source driver which reconstructs the image before line by line driving out the pixels to the display unit (for example, the display panel 99) A timing controller 92 receives image data, calculates and decides the timing for each line of pixels to be displayed. This mechanism reduces the required bandwidth of transmitting the pixels to the display driver for display or from the other hand, reduces the required clock frequency of transmitting the pixels to the display drivers hence reduces the EMI issues.

The present invention provides solution of reducing the required bandwidth by compressing the image in the TV side and reconstructs image in the display device which can be done in variable points according to different available component with this invention of inserting compression and decompression unit separately. Therefore it reduces the required IO band width of the transmission bus.

The video chipset can also compresses the image before sending to the pixel bus for transmission with reduced data rate on the pixel bus, and implements the decompression unit into the display drivers with each driver responsible for driving the corresponding columns of an image to the display unit. The, the whole data path of the compressed pixels has reduced amount of data traffic.

It will be apparent to those skills in the art that various modifications and variations can be made to the structure of the present invention without departing from the scope or the spirit of the invention. In the view of the foregoing, it is intended that the present invention cover modifications and variations of this invention provided they fall within the scope of the following claims and their equivalents.

What is claimed is:

1. An apparatus of image data transmission between television subsystem and display subsystem, comprising:
a TV chipset unit functioning at least features as program tuning and selection, video and audio decompression, and in the video feature: de-interlacing and frame rate conversion from the received number of field or frame to the predetermined frame rate per second, constructing the frame images by referring to the accessed adjacent filed/frame pixels;
an image compression unit embedded in the TV side reduces the data rate of the decompressed and processed video images;
a pixel bus with transmission unit embedded in the TV side to submit the compressed image to the display device;
a pixel bus with receiving unit embedded in the side of display device to receive the compressed image;
An image decompression unit embedded in the display device reconstructs the received images previously compressed in the TV side and temporarily saves the decompressed image into a frame buffer storage device and waits for the predetermined right timing to be sent to the display unit; and
a display unit with pixel driving unit for accurately driving out the corresponding pixels to the predetermined points of a display unit.

2. The apparatus of claim 1, wherein the video decompression unit referring to adjacent field or frame of pixels will have another still image compression codec to compress the image before saving into the temporary buffer as referencing frames and to decompress the accessed pixels before being used as reference.

3. The apparatus of claim 1, wherein the video de-interlacing referring to adjacent field or frame of pixels will have another still image compression codec to compress the image before saving into the temporary buffer as referencing frames and to decompress the accessed pixels before being used as reference.

4. The apparatus of claim 1, wherein the frame rate conversion unit referring to adjacent field or frame of pixels will have another still image compression codec to compress the image before saving into the temporary buffer as referencing frames and to decompress the accessed pixels before being used as reference.

5. The apparatus of claim 1, wherein the pixel bus for transmitting and receiving pixels of image is comprised of a predetermined voltage level of data signal swing to represent the logic “0” or “1” with referencing signal submitting together with the pixel data line to differentiate logic signal “0” and “1”.

6. The apparatus of claim 1, wherein the pixel bus for transmitting and receiving pixels of image is an LVDS. Low Voltage Differential Signal bus with low signal swing between logic “0” and “1”.

7. The apparatus of claim 1, wherein the image data are compressed and putting to the LVDS bus for transmission and are decompressed in the receiver terminal before sending to the display controller.

8. An apparatus of image data transmission between television subsystem and display subsystem, comprising:
a TV chipset unit functioning at least features as program tuning and selection, video and audio decompression, and in the video feature: de-interlacing and frame rate conversion from the received number of field or frame to the predetermined frame rate per second, constructing the frame images by referring to the accessed adjacent filed/frame pixels;
a pixel bus with transmission unit embedded in the TV side to submit the decompressed and processed images to the display device;
a pixel bus with receiving unit embedded in the side of display device to receive the decompressed and processed images sent from the TV side;
a control unit in the display device determines the timing of presenting the corresponding pixels to the display driver with an image compression and decompression unit, compressing the image before temporarily saving to the pixel buffer and decompressing the frame pixels accessed from the temporary pixel buffer before sending to the display driving devices; and
a display unit with pixel driving devices for accurately driving out the corresponding pixels to the predetermined points of the display unit.

9. The apparatus of claim 8, wherein in the display device, the compression unit is embedded in the display timing control unit and reduces the pixels data rate of an image before saving into a temporary pixel buffer.

10. The apparatus of claim 8, wherein in the display device, the decompression unit is embedded in the display timing control unit and reconstructs the pixels of an image line by line before sending into the display drivers.

11. The apparatus of claim 8, wherein in the display device, when integrating the compression unit into the timing controller, the temporary pixel buffer memory density is reduced.

12. The apparatus of claim 8, wherein in the display device, when integrating the compression unit into the timing controller, the temporary pixel buffer memory I/O bus width is reduced by a factor of at least two.

13. An apparatus of image data transmission between television subsystem and display subsystem, comprising:
a TV chipset unit functioning at least features as program tuning and selection, video and audio decompression, and in the video point: de-interlacing and frame rate conversion from the received number of field or frame to the predetermined frame rate per second, constructing the frame images by referring to the accessed adjacent filed/frame pixels;
a pixel bus with transmission unit embedded in the TV side to submit the decompressed and processed images to the display device;
a pixel bus with receiving unit embedded in the side of display device to receive the decompressed and processed images sent from the TV side;
a control unit in the display device determines the timing of presenting the corresponding pixels to the display driver with an image compression unit which compresses the image before temporarily saving to the pixel buffer; and
a display unit with pixel driving devices with image decompression unit embedded in each corresponding display driving device to decompressing the corresponding lines of pixels for accurately driving out the corresponding reconstructed pixels to the predetermined points of the display unit.

14. The apparatus of claim 13, wherein in the display driver side, at least one line buffer is built inside each of the display driver and a decompression unit recovers a whole line of pixels to be driven out to the display device.

15. The apparatus of claim 13, wherein in the display driver, the decompression unit is embedded in the display driver which receives a compressed line of pixels from the display timing control unit and decompresses the line pixels and drives out pixels of an image line by line to the display device.

16. The apparatus of claim 13, wherein in the display driver, the decompression unit embedded inside the display driver reconstructs the corresponding lines of pixels and drives out the pixels to the corresponding location of the display device.

17. The apparatus of claim 13, wherein in the display device, when integrating the compression unit into the timing controller and the decompression unit into the display drivers, the temporary pixel buffer memory density is reduced by a factor of at least two.

18. The apparatus of claim 13, wherein in the display device, when integrating the compression unit into the timing controller and the decompression unit into the display drivers, the temporary pixel buffer memory I/O bus width is reduced by a factor of at least two.

19. The apparatus of claim 13, wherein in the TV side, a compression unit reduces the data rate of the image and sends through a pixel us to the display unit, and the compressed image pixels are temporarily saved in a frame buffer till the decompression unit in the display driver reconstructs the pixels and drives them out to the corresponding location of a display device.
